(19) United States
(12) Patent Application Publication
(10) Pub. No.: US 2005/0021677 A1
(43) Pub. Date: Jan. 27, 2005

(54) Information providing method, server, and program

(75) Inventors: Yoshinori Musha, Kokubunji (JP); Yuichi Kobayashi, Sagamihara (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 10/842,544

(22) Filed: May 11, 2004

(30) Foreign Application Priority Data
May 20, 2003 (JP) 2003-142031

(51) Int. Cl. G06F 15/16

(52) U.S. Cl. 709/218

(57) ABSTRACT

An object of the present invention is to provide an information providing system and method for timely providing relevant information matching users' interests changing momentarily according to users' access to arbitrary pages. Another object thereof is to make the contents of each page in a list display of relevant information easier to be understood. In an information processing server and a terminal connected with a network, partial information in which a user is considered to be interested is extracted from contents displayed in the terminal, and it is transmitted to the information processing server. Information relevant to the partial information is searched for, and sent back to a browser of the terminal. Thereby, information relevant to the information in which the user is considered to be interested is timely provided to the user, and phrases characterizing each page in a page set of search results are extracted and displayed as a list display.

### CLAIM OF PRIORITY

The present application claims priority from Japanese application JP 2003-142031 filed on May 20, 2003, the content of which is hereby incorporated by reference into this application.

### FIELD OF THE INVENTION

The present invention relates to a method of effectively providing users with information in which the users are considered to be interested, in an information processing server and terminals that are connected with a network.

### BACKGROUND OF THE INVENTION

There have been conventionally several known methods of providing users on WWW (World Wide Web) with information including advertisements in which the users are considered to be interested, according to information inputted from the users.

For example, (1) user individual portal pages are prepared on a network, and according to preference information registered in advance by the users and information described in a scheduler, information is provided to the users accessing the pages. This method is described in JP-A No. 49832/2002.

(2) Similarly, according to information inputted to the portal pages, mail containing URL to the information to be provided is sent. This method is described in JP-A No. 7850/2002.

(3) As another method, the users access search sites and information relevant to keywords inputted for the search is provided separately (an example showing this is AdWords(tm) advertisement service (http://adwords.google.com) of Google).

In these prior arts, particularly when the information to be provided is advertisement information from a sponsor, it is important to cause the users to have interest to prompt them to positively click URL links.

As a method of displaying a list of search results, (4) conventional search sites input keywords as search keys and display phrases containing the keywords extracted from searched pages as a list display. This method is an effective method because the phrases containing the keywords probably contain information in which the users are interested.

As a method of providing relevant information to users having interest, with the prior art (1), users positively desiring information can obtain information matching preference information with a high probability by visiting portal pages prepared for individuals.

With the prior art (2), users not positively visiting portal pages as they do in (1) can be informed of the existence of information by mail to invite them to the portal pages. These prior arts (1) and (2) are useful to provide preference information that the users are considered to always have.

However, users' interests may change momentarily according to situations and their current thoughts. Therefore, information in which the users are considered to be interested at this very moment cannot be always provided.

Accordingly, with the prior art (3), since search sites used by many users to search for some information additionally provide relevant information, relevant information can probably be effectively provided for users having a positive desire for search. However, the relevant information cannot be provided only when the users visit the search sites and perform a search operation.

At the moment that a user visiting a certain page on WWW has a new interest while reading the page, if information relevant to the page can be timely provided, the user would be interested in the relevant information and click on it.

Therefore, an object of the present invention is to provide an information providing system and method for timely providing relevant information matching users' interests changing momentarily according to users' access to arbitrary pages.

As a method of displaying a list of search results, with the prior art (4), it is apparent that inputted keywords are contained in a searched page. Therefore, there is a problem in that displayed phrases containing the keywords are not always information representing the page.

### SUMMARY OF THE INVENTION

Accordingly, another object of the present invention is to display phrases (characteristic phrases) representing characteristics of each page as a list of results instead of displaying phrases containing the keywords themselves, and thereby to make the contents of each page in the list display easier to understand.

The present invention is an information providing method for providing information to a browser browsing Web pages. The method includes the steps of: extracting information of Web contents noticed by a user from a display area of the browser; creating search keys from the extracted information; searching for second information to be provided to the browser based on the search keys; and displaying results of searching for the second information along with the browser's Web contents. When the user selects results of searching for the second information, details of the second information are displayed on the browser.

The second information is composed of characteristic phrases characterizing each piece of information of the search results.

### BRIEF DESCRIPTION OF THE DRAWINGS

FIG. 1 shows an embodiment of the present invention, and is a block diagram showing an outline of a system and a data flow;

FIG. 2 is a block diagram showing an outline of a system using meta search and a data flow;

FIG. 3 is a schematic diagram showing the extraction of noticed text;

FIG. 4 is a schematic diagram showing GUI of an advertisement providing browser (or information providing browser) of tab menu type;

FIG. 5 is a schematic diagram showing a list of grouped search results in the browser of tab menu type;

FIG. 6 is a schematic diagram showing GUI of an advertisement providing browser (or information providing browser) of hierarchical display type;

FIG. 7 is a schematic diagram showing GUI of an advertisement providing browser (or information providing browser) of space display type;

FIG. 8 is a schematic diagram showing GUI of an advertisement providing browser (information providing browser) using cellular phones;

FIG. 9 is a block diagram showing a data flow for extracting parts of characteristic phrases from search results;

FIG. 10 is a PAD diagram showing an operation procedure on advertisement information provision by an advertisement providing (or information providing) browser;

FIG. 11 is a PAD diagram showing an operation procedure of an information processing server in advertisement providing service;

FIG. 12 is a data flow chart showing a method of collecting information on WWW in an information processing server of information providing service;

FIG. 13 is a block diagram showing a data flow when advertisements relevant to user's access information inputted via a proxy are provided to the user; and

FIG. 14 shows an embodiment in which advertisement search and grouping, and a function for extracting characteristic phrases are provided at the side of a browser, and is a block diagram showing an outline of a system and a data flow.

### DETAILED DESCRIPTION OF THE PREFERRED EMBODIMENTS

Hereinafter, preferred embodiments of the present invention will be described in detail with reference to the drawings.

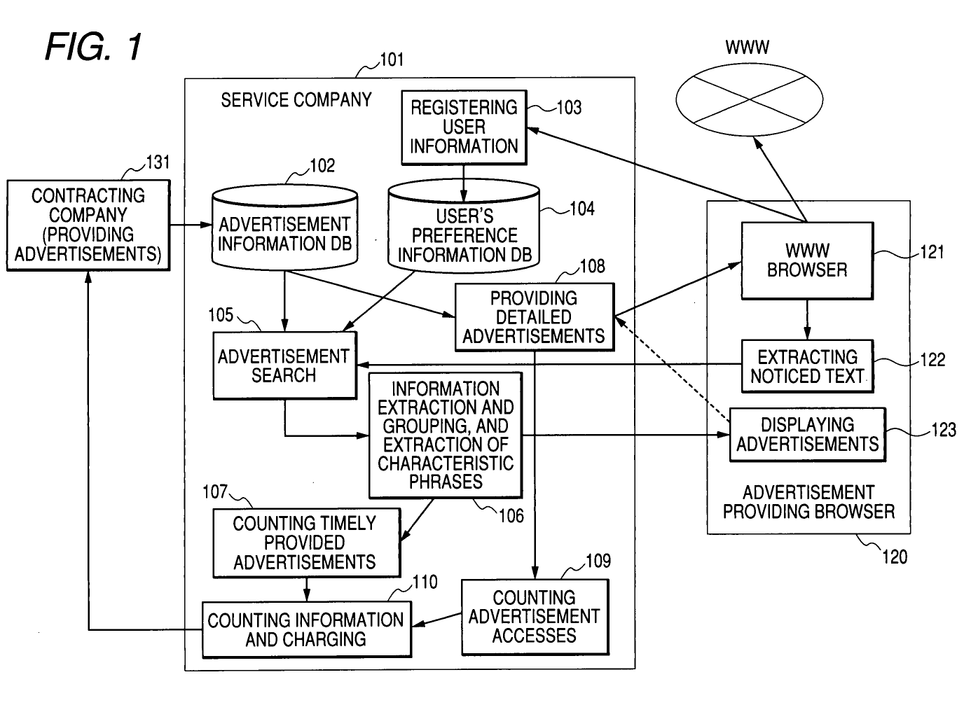

FIG. 1 is a block diagram showing a data flow when users are provided with advertisements relevant to users' noticed information extracted from a WWW browser.

A reference numeral 101 designates an information processing server of a service company that provides advertisement information. 120 designates an advertisement providing browser including a noticed text extracting part 122 that extracts users' noticed information and an advertisement display panel 123 that displays advertisement information, which are added to a conventional WWW browser part 121. The advertisement providing browser 120 is executed on a client computer (terminal) that can communicate with the information processing server 101 through a network.

A reference numeral 131 designates a contracting company that provides advertisements. The contracting company 131 registers advertisement information in an advertisement information database 102 of a service company beforehand.

The users use the WWW browser function 121 of the advertisement providing browser 120 to register information such as users' preferences and interesting fields beforehand through users' portal sites provided in the information processing server 101 (user information registration part 103). This information is stored in a users' preference information database 104.

Now, assume that the users are viewing arbitrary pages on WWW. The noticed text extracting part 122 extracts text information contained in a range displayed by the users or a partial area on a page (Web contents) traced by a mouse as a search key. In the same way, if the users are using a special device such as an eye controlled focus system, an area of a page at which the users are gazing is located, and text information contained therein is extracted as a search key.

The extracted text information is transmitted to the information processing server 101. The information processing server 101 uses received information from the noticed text extracting part 122 and user preference information stored beforehand in the preference information database 104 to search for advertisements in the advertisement search part 105. A characteristic phrase extracting part 106 groups pages based on the search result and extracts phrases indicating characteristics (characteristic phrases) to create a page for advertisement display.

The created page for advertisement display is transmitted to the advertisement display panel 123 of the advertisement providing browser 120, and an advertisement (second information) is displayed.

Thereby, advertisement information relevant to information noticed by the users among contents displayed on WWW pages is provided timely to the users, and advertisements corresponding to momentarily changing users' interests can be displayed quickly.

If the users are interested in an advertisement, and click on URL associated with the advertisement, a detailed advertisement read from the advertisement information database 102 within the information processing server 101 is transmitted from the detailed advertisement providing part 108 to the advertisement providing browser 120, and provided to the users in the WWW browser part 121.

On the other hand, in the information processing server 101, advertisements that are searched for by the characteristic phrase extracting part 106 and transmitted to the advertisement display part 123 are counted in a timely provided advertisement counting part 107. The users select advertisements in the advertisement display panel 123, and detailed advertisements provided by a detailed advertisement providing part 108 are counted in the advertisement access counting part 109. In the counting and charging part 110, charging is performed for the counted advertisements for each of contracting companies, and the contracting company 131 is charged for advertisement fees on an as-used basis.

By the way, when the noticed text extracting part 122 extracts noticed text, in order not to handle information that must not be transmitted to a server such as credit card numbers, text information is not extracted from pages encrypted by SSL or the like. This can be judged by whether or not URL starts with “https://”.

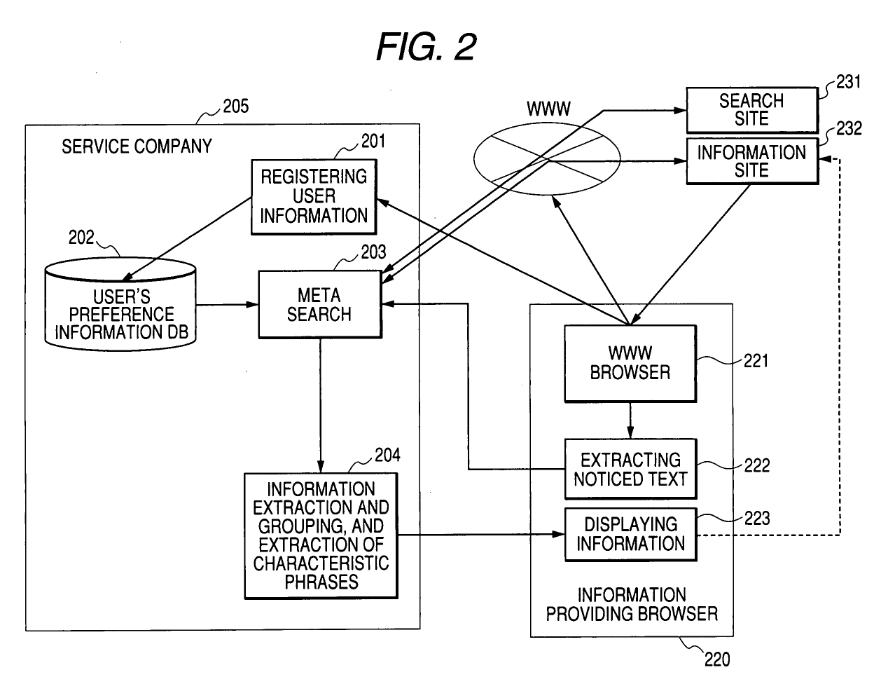

FIG. 2 is a data flow chart showing a method of providing an automatic meta search function on WWW.

Meta search is a search method for enabling collective processing for search results obtained using plural search sites such as a search site 231 and an information site 232 in the figure.

A reference numeral 205 in the figure designates an information processing server of a service company that provides the meta search function. Like FIG. 1, 220 designates an information providing browser including a noticed text extracting part 222 and an information display part 223, which are functionally added to a WWW browser 221. The information providing browser 220 is executed on a client computer that can communicate with the information processing server 205 through a network.

The users beforehand register user information such as preferences and interesting genres at portal sites of an information processing server 205 (user information registration part 201), and the information is stored in a user preference information database 202.

Now, assume that the users are displaying arbitrary pages in the WWW browser part 221. Like FIG. 1, when noticed text is extracted in the noticed text extracting part 222, the extracted text is transmitted to the meta search part 203, connection is made to the predetermined search site 231 and information site 232 on the WWW, and searching is performed using the extracted text.

In the characteristic phrase extracting part 204, information is extracted from search results of the sites 231 and 232, pages are grouped, and characteristic phrases are extracted and provided to the information display part 223 of the information providing browser 220 as second information.

If the users select the information of the information display part 223, the page of interest is displayed in the WWW browser part 221.

Thereby, advertisement information (second information) relevant to information noticed by the users among contents displayed on WWW pages is provided timely to the users, and the second information corresponding to momentarily changing users' interests can be displayed quickly.

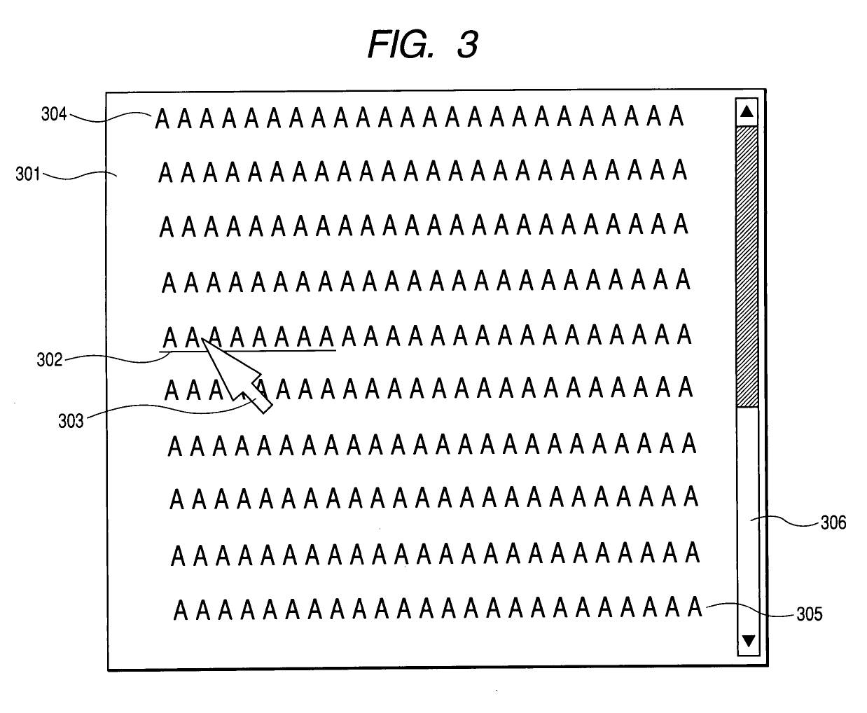

FIG. 3 is a schematic diagram showing the extraction of noticed text.

A reference numeral 301 designates a display part of WWW browser. Displayed text information is indicated by “AAA . . . ”.

Assume that a user points to an area portion 302 containing text information by using a mouse cursor 303. The noticed text extracting parts 122 and 222 accumulate time during which the mouse cursor 303 has stayed in the area. An area is provided for each HTML. The stay time of the mouse cursor 303 in each area is accumulated, and text information contained in an area having cumulative time exceeding a given threshold value is extracted as noticed text. This processing is repeated every constant cycle. The each area described above is a small area produced by surrounding long text every given number of characters by predetermined tags free from influence on display, aside from tags of original HTML. This is done to judge noticed text in more detail. The small area may be produced, for example, immediately after a page is read into the WWW browser part 221.

When a range displayed is changed by a scrollbar 306, a first portion 304 and a last portion 305 of a displayed page area are detected, and text information contained therebetween is extracted as display information. As much display information as may be read instantly by the user is displayed when it has been presented to the user.

Therefore, an extraction range of noticed text can be accurately determined based on the history of user's browser operations such as a stay time of the mouse cursor 303 and a display range (display information) determined by operations on the scroll bar 306.

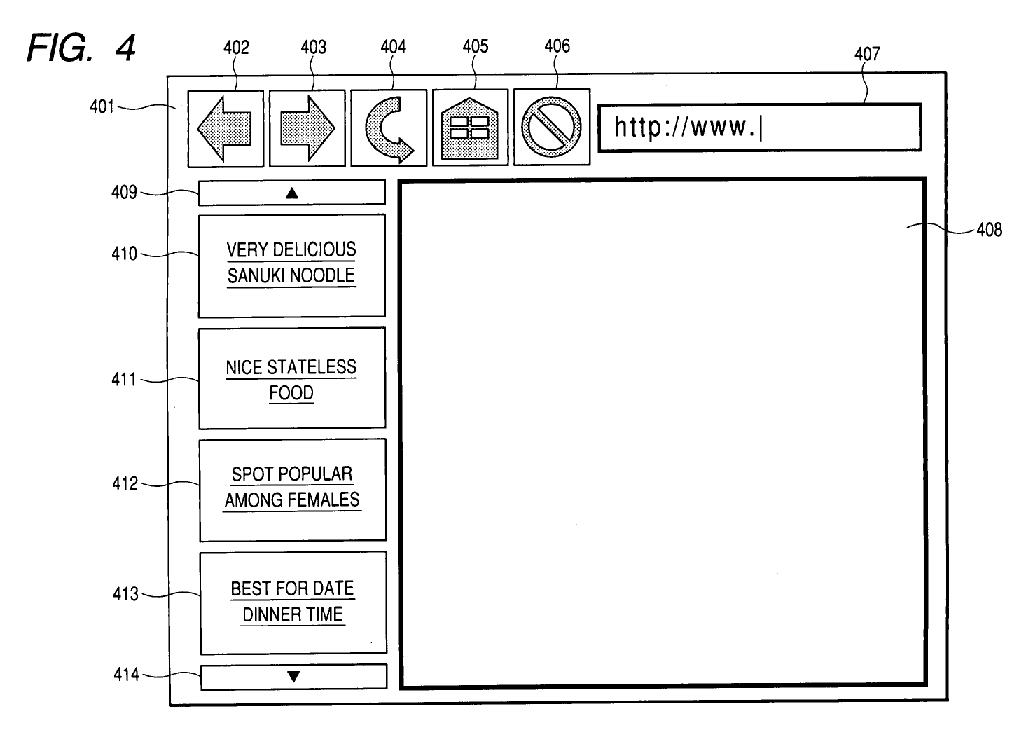

FIG. 4 is a schematic diagram showing a graphic user interface (hereinafter referred to as GUI) of an advertisement providing browser (or information providing browser) of tab menu type.

A reference numeral 401 designates a browser. A reference numeral 408 designates a display part of a conventional WWW browser (a first display area). The browser has buttons included in conventional WWW browsers such as “Return” 402, “Advance” 403, “Reread” 404, “Home page” 405, “Read cancel” 406, and URL input part 407. At the left side of FIG. 4, advertisements (information) timely grouped by the above-mentioned information processing servers 101 and 205 are displayed. The area where buttons 409 and 414 described later and characteristic phrases 410-413 are displayed is an advertisement display area (a second display area).

In FIG. 4, parts of four grouped characteristic phrases are displayed in fields 410, 411, 412, and 413. Groups not displayed, if any, can be moved up and down by pressing 409 and 414 buttons. Furthermore, URL links are attached to the fields 410-413 of the characteristic phrases. When the user clicks the fields, items (contents of Web page) belonging to the groups concerned can be displayed.

Therefore, to display a list of results of search by noticed text, instead of displaying text containing the noticed text itself used as a search keyword, by displaying phrases (characteristic phrases) representing characteristics of the Web pages, the contents of the pages become easier to be understood. Furthermore, by attaching URL links to the characteristic phrases, the effect of prompting the user for clicking can be increased. This method is particularly effective when the page to be searched is limited to a specific database and genre and contains no diversified information.

Moreover, emphasizing words (characteristic words) indicating the characteristics of each group would make greater impression on the user. For example, “noodles” and “delicious” are such appealing words in the characteristic phrase 410.

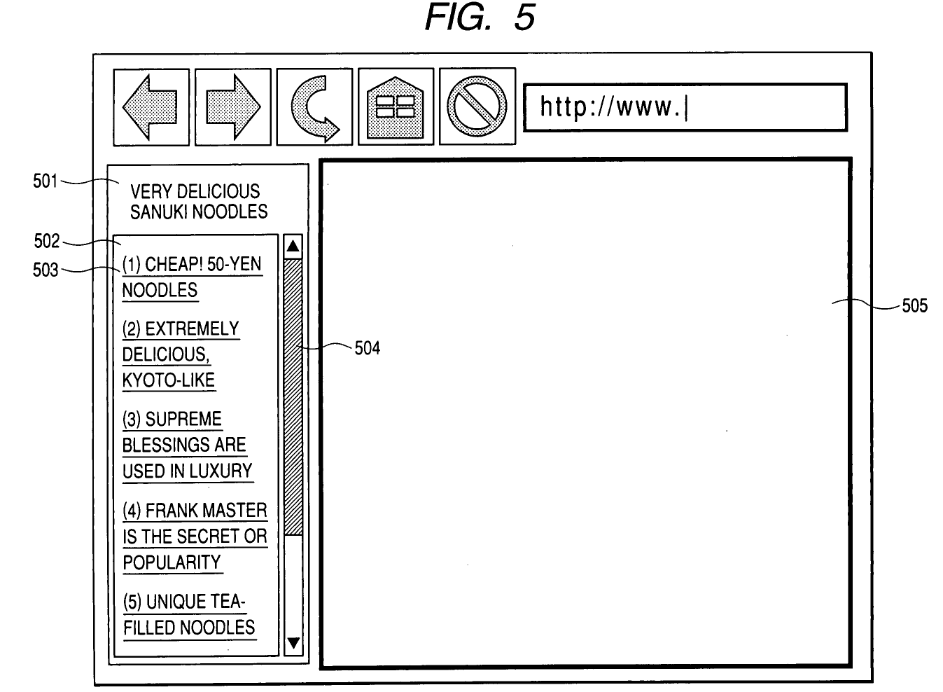

FIG. 5 is a schematic diagram showing a list of grouped search results in the browser of tab menu type shown in FIG. 4.

FIG. 5 shows the case where the characteristic phrase 410 of FIG. 4 is selected by clicking. A sub-window 501 displays parts of characteristic phrases indicating a group, and a list of information items contained in the characteristic phrase 410 are displayed in an advertisement (information) display part 502. Advertisements (information) that cannot be displayed in the advertisement display part 502 can be displayed by operating a scroll bar 504. A URL link is attached to each information item. For example, when a link 503 is selected by clicking, its detailed advertisement (or original informational) is displayed in a WWW browser display part 505.

In this way, since more detailed information is displayed in the advertisement display part 502 by clicking the characteristic phrase shown in FIG. 4, information on the characteristic phrase 410 in which the user is interested can be transmitted without occupying a WWW browser display part 505. Moreover, since a Web page on an advertisement is not displayed in the WWW browser part 505 until the link 503 is clicked, the user can browse advertisements without a sense of incongruity, based on his or her will.

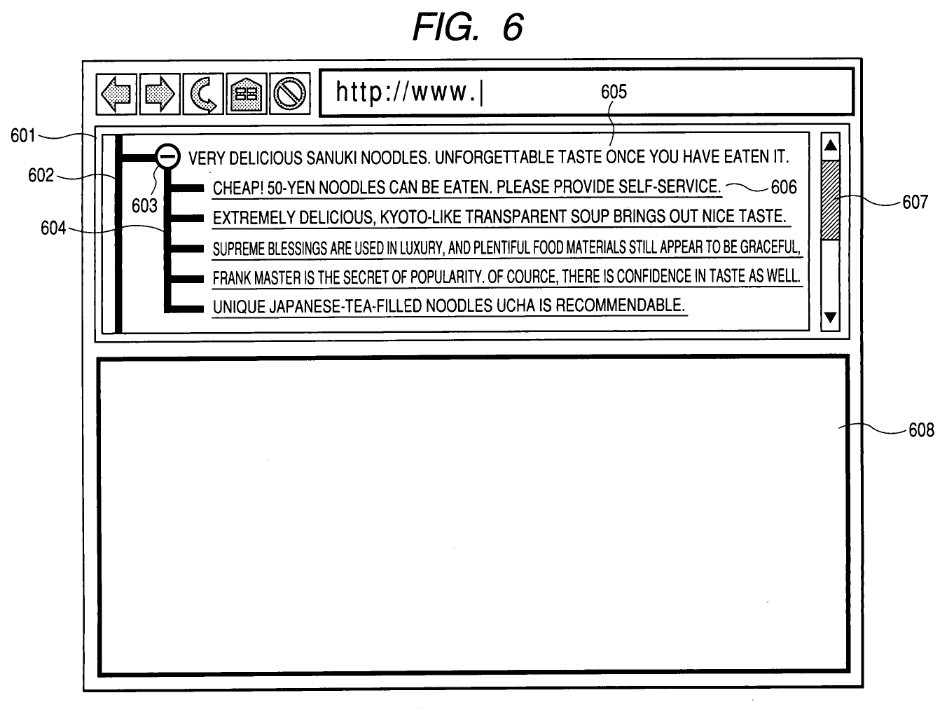

FIG. 6 is a schematic diagram showing GUI of an advertisement providing browser (or information providing browser) of hierarchical display type.

A reference numeral 601 designates a portion in which provided information is displayed; a group and items in it are displayed in a tree structure. Part 605 of the characteristic phrase of the group is displayed in a form that hangs from a trunk 602 of the route.

By clicking a node 603, as shown in the figure, parts of characteristic phrases of a list of information items belonging to the group are expanded and displayed as branches 604. URL links 606 are attached to characteristic phrases of the branches 604 relevant to the node 603. For example, when a characteristic phrase 606 is selected, detailed advertisement (or original information) on the phrase is displayed in a display part 608 of the WWW browser.

A list of information items not displayed in the information providing part 601 can be displayed by operating a scroll bar 607.

Also in the browser of hierarchical display type, since more detailed information is expanded as the branches 604 by clicking the node 603, information on the characteristic phrase 410 in which the user is interested can be transmitted without occupying the WWW browser display part 608. Moreover, since a Web page on an advertisement is not displayed in the WWW browser part 608 until the link 606 is clicked, the user can browse advertisements without a sense of incongruity, based on his or her will.

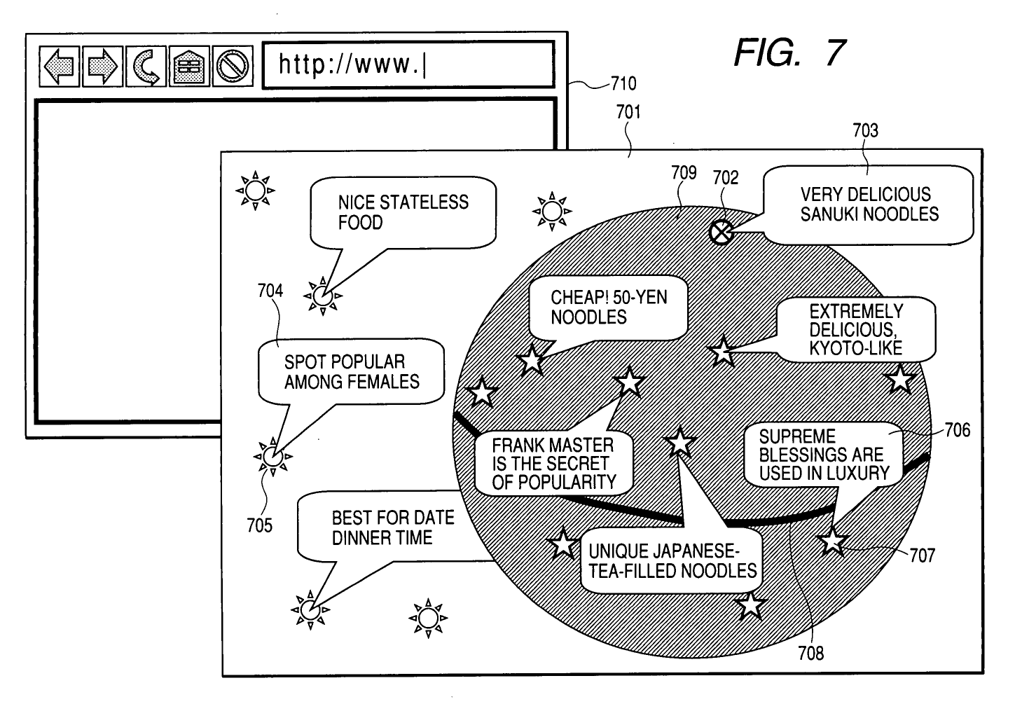

FIG. 7 is a schematic diagram showing GUI of an advertisement providing browser (or information providing browser) of space display type.

Separate windows are displayed in a WWW browser part 710 and a provided information displaying part 701.

Each group of the provided information displaying part 701 is indicated by a sun mark 705, and characteristic phrases of the groups are displayed as balloons 704. A display range can be moved by the mouse operation. When the mouse is brought near to a sun mark without a balloon, a balloon is displayed.

By clicking and selecting the sun mark (symbol) 705, the user can open a celestial sphere 709 (third display area), for example. Its northern hemisphere part is displayed, and the celestial sphere 709 can be rotated in a direction along the equator 708 by mouse operations. Star marks 707, which are attached to the surface of the celestial sphere, denote a list of search results belonging to the group. The star marks 707 are provided with their respective characteristic phrases in a form of balloons 706.

The Arctic point 702 is provided with a balloon 703 of a characteristic phrase indicating the group. The celestial sphere can be closed by clicking the Arctic point 702. A new celestial sphere 709 can be displayed by clicking and selecting another sun mark 705.

Also in the browser 710 of space display type, since more detailed information is expanded as a celestial sphere 709 by clicking the sun mark 705, information on the characteristic phrase in which the user is interested can be transmitted. Moreover, since a Web page on an advertisement is not displayed in the WWW browser 710 until a star mark 707 within the celestial sphere 709 is clicked, the user can browse advertisements without a sense of incongruity.

Moreover, in the browser 710 of space display type, a characteristic phrase representing the group of advertisements or information is displayed within a balloon 704. By clicking a sun mark 705 corresponding to the balloon 704, a celestial sphere 709 corresponding to a characteristic phrase of the balloon 704 is expanded, details of the group of the balloon 704 can be browsed in a balloon 706 within the celestial sphere 709, and a display form changes each time a sun mark 705 or a star mark 707 is clicked. The adoption of characteristic phrases composed of short phrases within the balloons along with the varying WWW browser enables correct transfer of the purports of links.

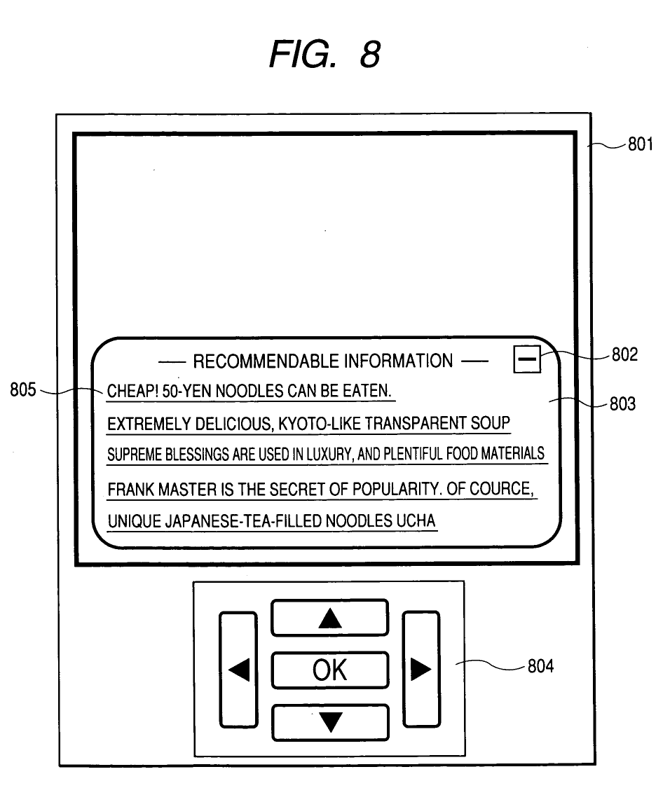

FIG. 8 is a schematic diagram showing GUI of an advertisement providing browser (information providing browser) using cellular phones.

A reference numeral 801 designates a contents display part. An operation part 804 includes up and down buttons for moving a cursor on the screen up and down, right and left buttons for advancing and returning contents, and an OK button for making confirmation.

FIG. 8 shows an example of provided information (advertisement information) displayed on a pop-up display part 803 as recommended information. As shown in 805 of the figure, characteristic phrases are partially displayed, and a URL link is attached to each of the characteristic phrases 805. When a selection by the up and down buttons of the operation part 804 has been confirmed, the display panel 803 disappears and detailed information is displayed on the contents display part 801.

As the user operates the cursor upwardly and scrolls display contents downward on the display panel, a panel close button 802 appears next to the characteristic phrases 805. If the user wants to close the display panel 803 without performing any operations, the user has only to select the close button 802.

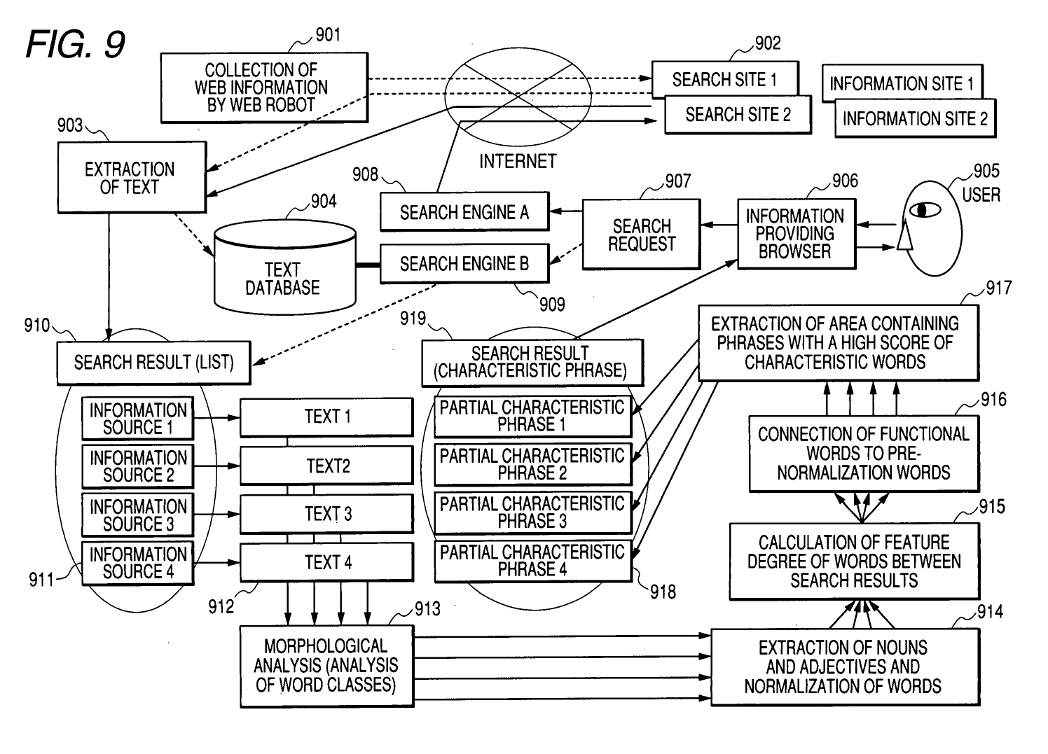

FIG. 9 is a block diagram showing a data flow for extracting parts of characteristic phrases from search results in the characteristic phrase extracting part 106 or 204 described above in the case where a grouping function is not provided.

When a user 905 displays WWW pages on an information providing browser 906, noticed text is extracted by the browser and a search request is passed to a search engine in a search request part 907.

For example, for meta search, in a search engine A (908) in the figure, searching is performed in a search site and an information site 902 through the Internet. A result of the search is sent to a text extracting part 903, where information is extracted and sent to 910 as a search result list.

In another route, information in the Internet is collected beforehand by a Web robot 901, and text information is extracted in 903 and stored in a text database 904. For a search request issued in a search request part 907, searching is performed through a text database 904 in a search engine B (909), and a result of the search is outputted as a search result list 910.

The search result list 910 contains a list of information sources 911 each of which is provided with text 912. Each text 912 is subjected to analysis of word classes based on morphological analysis in a morphological analysis part 913, and only nouns and adjectives are extracted by a normalizing part 914 to normalize the endings of words (standardize them for inflection).

After the normalization, in a characteristic degree calculation part 915, the characteristic degrees of the words are calculated in between search result sets. Each word in each search result is returned to its ending before the normalization by a function word connection part 916, and connected with a function word such as particle and prefix.

An area extraction part 917 calculates the characteristic degrees of the deformed words in each phrase as scores, and extracts an area having a high score in a given length. The extracted area is outputted as parts 918 of characteristic phrases in each search result. These partial characteristic phrases 918 are a list of parts of characteristic phrases corresponding to each search result, and the list is sent to the information providing browser 906 and provided to the user.

In this way, from the result of searching the text database 904 based on extracted text noticed by the user, by calculation of characteristic degrees after morphological analysis and normalization, an area having a high degree of characteristics is extracted as characteristic phrases. Therefore, a summary of each information source can be correctly represented by short phrases.

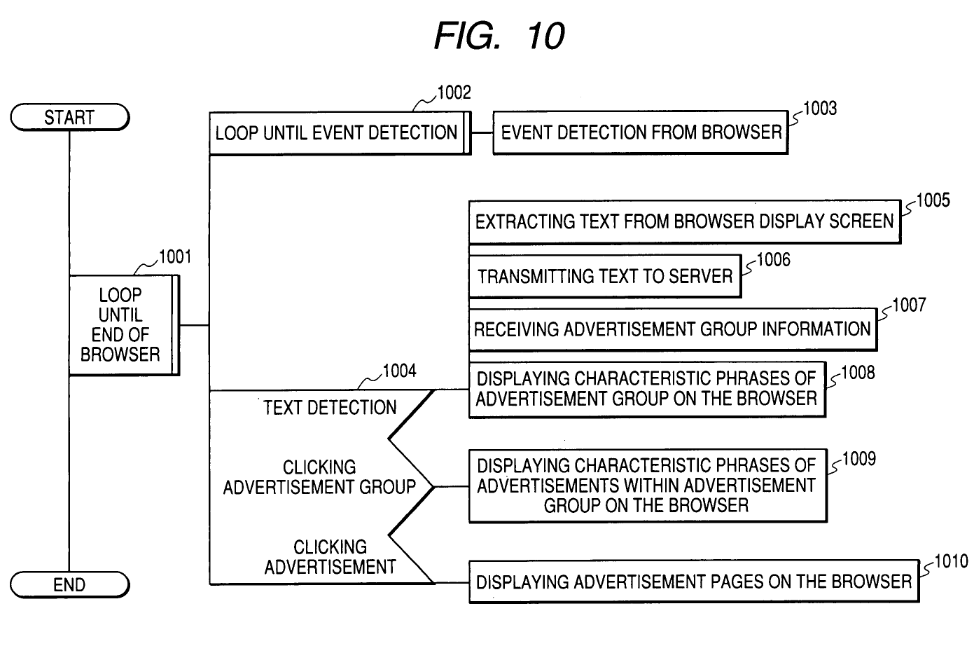

FIG. 10 is a PAD (Program Analysis Diagram) diagram showing an operation procedure on advertisement information provision by the advertisement providing (or information providing) browsers 120 and 220.

This processing corresponds to the noticed text extracting part 122 and the advertisement display part 123 of FIG. 1. Also, it corresponds to the noticed text extracting part 222 and the information display part 223 of FIG. 2. It is assumed that the advertisement providing browsers 120 and 220 operate in parallel with the conventional WWW browser part 121 or 221.

In step 1002, a processing loop is formed until a relevant event is detected in a browser screen. When the event is detected in step 1003, control exits from the loop of step 1002.

After exit from the loop, in step 1004, the event is checked, and if the event is detection of noticed text, control proceeds to step 1005 to extract the text.

In step 1006, the text extracted in step 1005 is transmitted to the information processing server 101 or 205. In step 1007, advertisement group information and detailed information are acquired from the information processing server. Then, in step 1008, the characteristic phrases of an advertisement group are displayed in the browser.

If the user clicks the advertisement group, the event is checked in step 1004, and advertisements belonging to the advertisement group are displayed on the browser in step 1009. If an advertisement is further clicked by the user, the event is checked in step 1004 and the advertisement page is displayed on the browser in step 1010. In 1001, the above-mentioned operation is repeated until the browser ends.

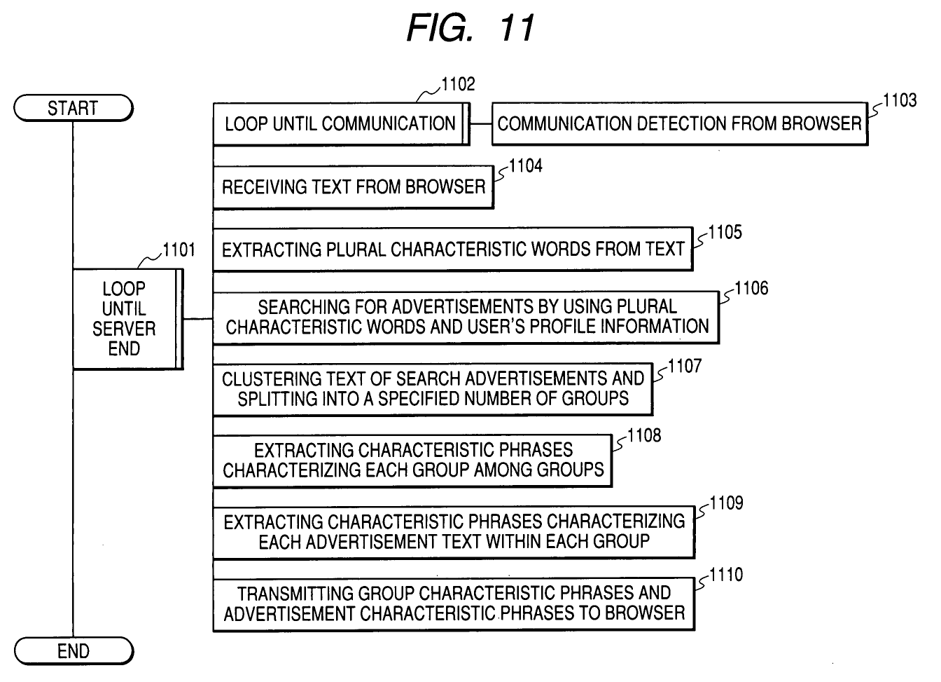

FIG. 11 is a PAD diagram showing an operation procedure of the information processing server 101 in the advertisement providing service of FIG. 1.

It is assumed that server process operates for each of the advertisement providing browsers 120 to be used. The information processing server 101, in the loop of step 1102, waits for communication from the advertisement providing browser 120. Upon detecting communication in step 1103, it exits from the loop of step 1102, and in step 1104, receives user's noticed text from the advertisement providing browser 120. In step 1105, it extracts plural characteristic words from the noticed text.

In step 1106, the information processing server 101 searches the advertisement information database 102 by using plural extracted characteristic words and preference information in user's profile. In step 1107, it clusters searched advertisement text, and splits it into a predetermined number of groups.

In the next step 1108, characteristic phrases of each group among the groups are extracted as in FIG. 9. In step 1109, furthermore, characteristic phrases characterizing each advertisement among advertisements belonging to each group are extracted. In step 1110, these group characteristic phrases and advertisement characteristic phrases are transmitted to the advertisement providing browser 120. In step 1101, a processing loop is formed until the server ends.

By the above-mentioned processing, noticed text is automatically extracted from the user's browser operations, plural characteristic words are extracted from the noticed text to search for advertisements, the search results are differentiated from each other and split into a predetermined number of groups, and characteristic phrase characterizing groups and characteristic phrases characterizing advertisements within the groups are respectively extracted. Thereby, to the browsers shown in FIGS. 5 to 8, advertisements close to user's current interest can be transmitted along with their purports clarified by short characteristic phrases, with the effect that browsers' advertisement display areas can be reduced.

By using a user's profile (preference information), when advertisements are searched for based on text extracted from the browsers, results optimum to the user can be obtained.

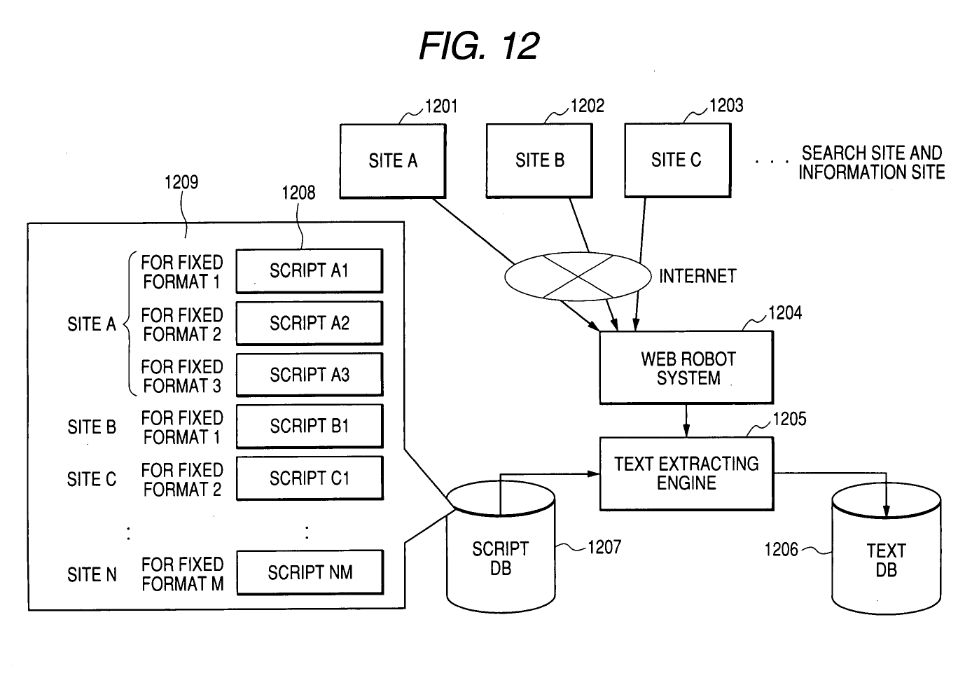

FIG. 12 is a data flow chart showing a method of collecting information on WWW in the information processing server 205 of the information providing service of FIG. 2.

Site A 1201, site B 1202, and site C 1203 are connected to the Internet as shown in the figure. These are assumed as search sites and information sites that automatically create pages in conjunction with databases.

A Web robotic system 1204 (corresponding to 901 of FIG. 9) collects information from the sites A, B, and C registered in advance. Of information acquired from the plural sites, HTML files are passed to a text extracting engine 1205 (corresponds to 903 of FIG. 9).

The text extracting engine 1205 prepares information collection rules such as corresponding scripts for HTML files of fixed format to collect desired text information. The scripts are stored in a script database 1207. Each script 1209 is prepared for each site and each fixed format. For example, script 1208 is script A1 prepared for fixed format 1 of site A. The text extracting engine 1205 can extract desired text information by applying a corresponding script to an acquired HTML file.

As an example of such scripts, XSLT converting XML syntax can be used as an existing technique. In this case, since HTML files must be XHTML files complying with XML, XSLT cannot be generally used in the present situation in which HTML files not complying with XML and HTML structurally corrupted exist. Accordingly, in actual operations, an effective technique is to locate specific text by only pattern matching of tags and text without assuming data structures complying with XML. In this case, the above-mentioned script contains command strings indicating the pattern and a procedure.

In this way, by preparing in advance scripts for each site and for each fixed format, desired text information can be correctly and quickly collected.

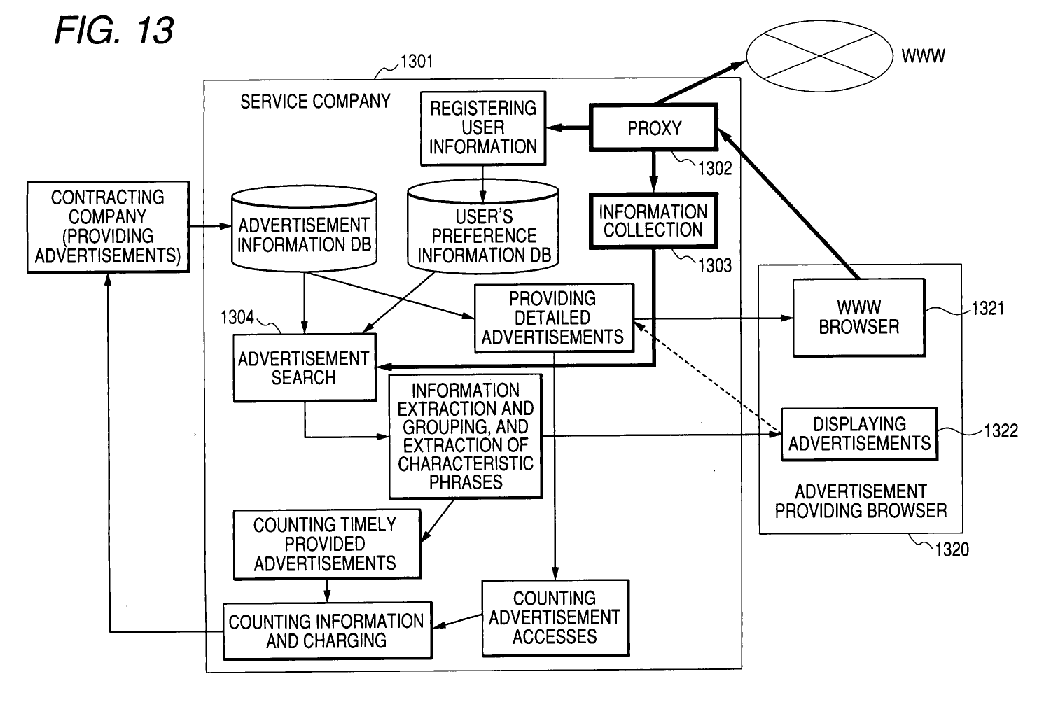

FIG. 13 shows the information processing server 101 of FIG. 1 to which a proxy is added. FIG. 13 is a block diagram showing a data flow when advertisements relevant to user's access information inputted via the proxy are provided to the user.

FIG. 13 is different from FIG. 1 in that a noticed text extracting part is deleted from an advertisement providing browser 1320, and an information processing server 1301 of a service company includes a proxy part 1302 and a part 1303 for collecting information from the proxy.

When the user accesses WWW by using a WWW browser 1321 registered to access WWW via the proxy part 1302, the WEB contents are displayed in the WWW browser 1321, information contained in the WEB contents is collected from the proxy part 1302 in the information collecting part 1303, and keywords or text is extracted and sent to an advertisement search part 1304. Subsequently, the same processing as in FIG. 1 is performed, and advertisements are displayed in an advertisement display part 1322.

As a model using the proxy part, the information processing server 205 shown in FIG. 2 may be provided with a proxy part and an information collecting part, like FIG. 13.

In the above-mentioned embodiment, text noticed by the user is extracted from text displayed in the WWW browser part 121, and the extracted text as a search key is used to search the advertisement information database 102 for advertisements suitable for user's interest. However, image data noticed by the user of the image data displayed in the www browser part 121 may be extracted and used as a search key to search for advertisements suitable for user's interest.

In this case, text may be estimated from the image data to search the advertisement information database 102 for advertisements. For example, text may be estimated from image data and used as a search key based on a technique disclosed in “Estimation of Relevant Words from Unknown Images by Split Clustering for Images Provided with Word Group” written by Yasuhide Mori, Hironobu Takahashi, and Ryuichi Oka, Electronic Information Communication Society Paper Magazine, D-11, Vol. 84-D11, No. 4, pp. 649-658, April 2001.

Or, image data is stored in the advertisement information database 102, and image data noticed by the user may be used as a search key to search for image data of the advertisement information database 102. A technique for using image data as a search key to search for image data is disclosed in “Query by Image and Video Content: The QBIC System” (M. Flickner H. Sawhney et. al., IEEE Computer, vol. 28, No. 9, pp. 23-32, September 1995). This technique may be applied.

In the above-mentioned embodiment, the advertisement searching part 105 and the characteristic phrase extracting part 106 are mounted in the information processing server 101. However, the advertisement searching part 105 and the characteristic phrase extracting part 106 may be mounted in a client computer side, that is, the advertisement providing browser 120, in which case the same effect as the foregoing can be obtained. In this case, since the information processing server 101 may manage database processing of the preference information database 104 and the advertisement information database 102, and information on charging on the contracting company 131, the configuration of the system can be simplified.

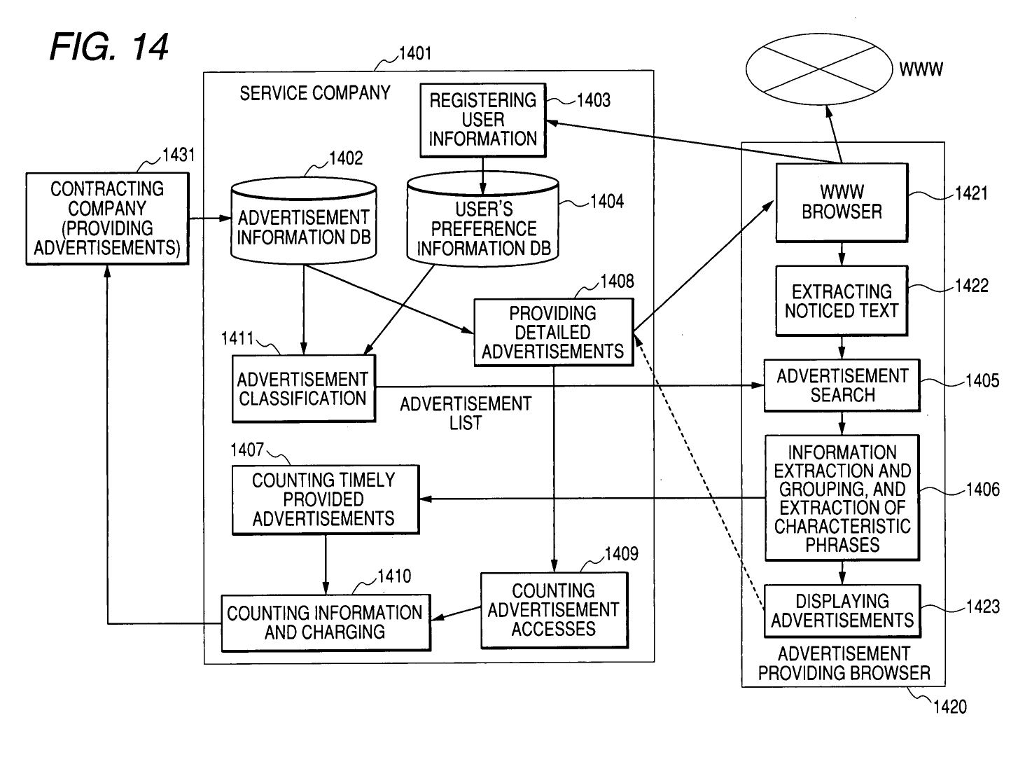

An embodiment of this configuration is shown in FIG. 14. In a service company 1401, advertisements have been classified in advance in an advertisement classifying part 1411 according to registered rough user preference information (favorite genres and the like, 1404). An advertisement list containing attribute information and text information included in advertisements and URLs to detailed advertisements is sent to an advertisement searching part 1405 of the browser 1420 and stored as temporary recording therein. In the browser 1420, when noticed text is extracted in 1422, the extracted information is used as a search key to perform searching for advertisement attribute information and text information of the advertisement list in 1405. For text information obtained as a result, in 1406, information is extracted and grouped, and characteristic phrases are extracted. Thereafter, detailed advertisements are displayed as in FIG. 1.

A characteristic of this embodiment is that since extraction processing for text noticed by the user is confined within the browser, very detailed privacy information such as locations momentarily noticed by the user need not be passed to the server. The system configuration is effective from the viewpoint of private information protection.

In the above-mentioned embodiment, a description has been primarily made of the case where advertisements corresponding to momentarily changing user's interests are provided. However, the present invention is not limited to advertisements as long as information (e.g., news and site information) corresponding to user's interests is provided.

The information providing method for providing information to a browser browsing Web pages includes the steps of: extracting information of Web contents noticed by a user from a display area of the browser; creating search keys from the extracted information; searching for second information to be provided to the browser based on the search keys; and displaying results of searching for the second information along with the browser's Web contents. The step of creating search keys from the extracted information extracts plural characteristic words from the extracted information and uses the plural characteristic words as search keys.

The information providing method for providing information to a browser browsing Web pages includes the steps of: extracting information of Web contents noticed by a user from a display area of the browser; creating search keys from the extracted information; searching for second information to be provided to the browser based on the search keys; and displaying results of searching for the second information along with the browser's Web contents. When the user selects the second information, details of the second information are displayed in the browser.

The information providing method for providing information to a browser browsing Web pages includes the steps of: extracting information of Web contents noticed by a user from a display area of the browser; creating search keys from the extracted information; searching for second information to be provided to the browser based on the search keys; and displaying results of searching for the second information along with the browser's Web contents. The step of displaying results of searching for the second information along with the browser's Web contents includes the steps of: extracting characteristic phrases of each piece of information from the result of searching for the second information; and displaying the characteristic phrases in the browser, wherein the characteristic phrases are highlighted.

The information providing method for providing information to a browser browsing Web pages includes the steps of: extracting information of Web contents noticed by a user from a display area of the browser; creating search keys from the extracted information; searching for second information to be provided to the browser based on the search keys; and displaying results of searching for the second information along with the browser's Web contents. The step of displaying results of searching for the second information along with the browser's Web contents includes the steps of: extracting characteristic phrases of each piece of information from the result of searching for the second information; and displaying the characteristic phrases in the browser. The step of extracting characteristic phrases groups plural results of searching for the second information and extracts characteristic phrases characterizing each of groups. The step of displaying characteristic phrases in the browser highlights the characteristic phrases for a list display every group.

The information providing server that provides information to a browser of a terminal connected via a network includes: a search key extracting means that extracts search keys from information of Web contents browsed by the terminal; an information searching means that searches at least one of a preset database or web site for second information, based on the search keys; and a second information transmitting means that transmits results of searching for the second information to the browser of the terminal, and displays the second information along with the Web contents. The information searching means performs the searching based on user information set beforehand in addition to the search keys.

The information providing server that provides information to a browser of a terminal connected via a network includes: a search key extracting means that extracts search keys from information of Web contents browsed by the terminal; an information searching means that searches at least one of a preset database or web site for second information, based on the search keys; and a second information transmitting means that transmits results of searching for the second information to the browser of the terminal, and displays the second information along with the Web contents. The information searching means performs the searching based on preset user information in addition to the search keys. The second information transmitting means includes a characteristic phrase extracting means that extracts characteristic phrases of each piece of information from the results of searching for the second information, and transmits the characteristic phrases to the browser.

The information providing server that provides information to a browser of a terminal connected via a network includes: a search key extracting means that extracts search keys from information of Web contents browsed by the terminal; an information searching means that searches at least one of a preset database or web site for second information, based on the search keys; and a second information transmitting means that transmits results of searching for the second information to the browser of the terminal, and displays the second information along with the Web contents. The information searching means performs searching in accordance with information collection rules predetermined for each Web site.

The information providing server that provides information to a browser of a terminal connected via a network includes: a search key extracting means that extracts search keys from information of Web contents browsed by the terminal; an information searching means that searches at least one of a preset database or web site for second information, based on the search keys; and a second information transmitting means that transmits results of searching for the second information to the browser of the terminal, and displays the second information along with the Web contents. The second information transmitting means includes a characteristic phrase extracting means that extracts characteristic phrases of each piece of information from the results of searching for the second information, and transmits the characteristic phrases to the browser. The characteristic phrase extracting means groups plural results of searching for the second information and extracts characteristic phrases characterizing each of groups. The second information transmitting means transmits characteristic phrases of each group to the browser.

The information providing server that provides information to a browser of a terminal connected via a network includes: a search key extracting means that extracts search keys from information of Web contents browsed by the terminal; an information searching means that searches at least one of a preset database or web site for second information, based on the search keys; and a second information transmitting means that transmits results of searching for the second information to the browser of the terminal, and displays the second information along with the Web contents. The second information transmitting means includes a characteristic phrase extracting means that extracts characteristic phrases of each piece of information from the results of searching for the second information, and transmits the characteristic phrases to the browser. The characteristic phrases are associated with URL of the second information.

The information providing server that provides information to a browser of a terminal connected via a network includes: a search key extracting means that extracts search keys from information of Web contents browsed by the terminal; an information searching means that searches at least one of a preset database or web site for second information, based on the search keys; and a second information transmitting means that transmits results of searching for the second information to the browser of the terminal, and displays the second information along with the Web contents. The information providing server includes a proxy to perform communication with the terminal or Web site.

The information providing server that provides information to a browser of a terminal connected via a network includes: a search key extracting means that extracts search keys from information of Web contents browsed by the terminal; an information searching means that searches at least one of a preset database or web site for second information, based on the search keys; and a second information transmitting means that transmits results of searching for the second information to the browser of the terminal, and displays the second information along with the Web contents. The second information transmitting means includes a characteristic phrase extracting means that extracts characteristic phrases of each piece of information from the results of searching for the second information, and transmits the characteristic phrases to the browser. The information providing server includes a proxy to perform communication with the terminal or Web site.

The information providing server that provides information to a browser of a terminal connected via a network includes: a search key extracting means that extracts search keys from information of Web contents browsed by the terminal; an information searching means that searches at least one of a preset database or web site for second information, based on the search keys; and a second information transmitting means that transmits results of searching for the second information to the browser of the terminal, and displays the second information along with the Web contents. The information providing server includes a detecting means that detects that the user selects the second information, and a detailed information transmitting means that, upon detecting that the second information has been selected, transmits detailed information of the second information.

The information providing server that provides information to a browser of a terminal connected via a network includes: a search key extracting means that extracts search keys from information of Web contents browsed by the terminal; an information searching means that searches at least one of a preset database or web site for second information, based on the search keys; and a second information transmitting means that transmits results of searching for the second information to the browser of the terminal, and displays the second information along with the Web contents. The second information transmitting means includes a characteristic phrase extracting means that extracts characteristic phrases of each piece of information from the results of searching for the second information, and transmits the characteristic phrases to the browser. The information providing server includes a detecting means that detects that the user selects the second information, and a detailed information transmitting means that, upon detecting that the second information has been selected, transmits detailed information of the second information.

The program that displays Web contents via a network includes: a display means that displays Web contents in a first display area; a noticed information extracting means that extracts information noticed by a user in the first display area; and a second display means that displays results of searching with the information as search keys in a preset second display area as second information. The second display means displays the second information as characteristic phrases characterizing it and displays the characteristic phrases in association with URL indicating the second information.

The program that displays Web contents via a network includes: a display means that displays Web contents in a first display area; a noticed information extracting means that extracts information noticed by a user in the first display area; and a second display means that displays results of searching with the information as search keys in a preset second display area as second information. The noticed information extracting means decides an area for extraction from the Web contents, based on a history of user display operations, and extracts information within the area as information noticed by the user. The second display means displays the second information as characteristic phrases characterizing it and displays the characteristic phrases in association with URL indicating the second information.

In the above-mentioned program, the second display means splits the characteristic phrases into plural groups for display and provides characteristic phrases representing each group with a link pointing to a characteristic phrase within the group.

In the above-mentioned program, the second display means splits the characteristic phrases into plural groups for a list display and highlights characteristic words contained in characteristic phrases representing each group.

In the above-mentioned program, the second display area hierarchically displays each group and characteristic phrases within the group.

In the above-mentioned program, the second display area displays each group and characteristic phrases within the group in accordance with preset symbols.

In the above-mentioned program, the symbols have a link pointing to a characteristic phrase within each group, and when the link is selected, a third display area is expanded, and symbols pointing to characteristic phrases are disposed within the third display area.

The information providing method of providing advertisements to a browser browsing Web pages includes the steps of: extracting information of Web contents noticed by a user from a display area of the browser; creating search keys from extracted information; searching for second information to be provided to the browser based on the search keys; displaying results of searching for the second information along with the browser's Web contents; detecting that the user has selected the second information; and calculating information on charging on advertisement sponsors, based on the detection result.

Therefore, according to the present invention, when the user browses arbitrary Web contents, since the advertisements and information relevant to the Web contents are timely provided, the user can obtain advertisements and information relevant to his or her interest while currently viewing pages. Thereby, the user can be prompted to select advertisements and information. In a list display of advertisements and information items, since characteristic phrases characterizing the advertisements and information items are displayed within a set of the outputs, the user can easily determine differences among the information items, and sponsors of information including the advertisements can effectively provide the information to the user. As a result, improvement in advertisement effects is expected, and the user can perform timely information collection operations because he or she is presented with attractive information when feeling interest.

1. An information providing method for providing information to a browser browsing Web pages, the method including the steps of:
extracting information of Web contents noticed by a user from a display area of the browser;
creating search keys from the extracted information;
searching for second information to be provided to the browser based on the search keys; and
displaying results of searching for the second information along with the browser's Web contents.

2. The information providing method according to claim 1,
wherein the step of extracting the Web contents decides an area from which the Web contents comprising text or images noticed by the user are to be extracted, based on a history of browser operations by the user.

3. The information providing method according to claim 1,
wherein the step of searching for the second information includes the step of splitting search results into groups.

4. The information providing method according to claim 1,
wherein the step of searching for the second information performs the searching based on user information set beforehand in addition to the search keys.

5. The information providing method according to claim 1,
wherein the step of searching for the second information searches at least one of a preset database or web site for the second information.

6. The information providing method according to claim 1,
wherein the step of searching for the second information performs the searching in accordance with information collection rules predetermined for each Web site.

7. The information providing method according to claim 1,
wherein the step of displaying results of searching for the second information along with the browser's Web contents includes the step of extracting characteristic phrases of each piece of information from the results of searching for the second information, and the step of displaying the characteristic phrases on the browser.

8. The information providing method according to claim 7,
wherein the step of extracting the characteristic phrases groups plural results of searching for the second information and extracts characteristic phrases characterizing each of groups, and
the step of displaying on the browser displays a list of characteristic phrases of each of the groups.

9. The information providing method according to claim 7,
wherein the characteristic phrases are associated with URL of the second information.

10. An information providing server that provides information to a browser of a terminal connected via a network, the information providing server including:
a search key extracting means that extracts search keys from information of Web contents browsed by the terminal;
an information searching means that searches at least one of a preset database or web site for second information, based on the search keys; and
a second information transmitting means that transmits results of searching for the second information to the browser of the terminal, and displays the second information along with the Web contents.

11. The information providing server according to claim 10,
wherein the second information transmitting means includes a characteristic phrase extracting means that extracts characteristic phrases of each piece of information from the results of searching for the second information, and transmits the characteristic phrases to the browser.

12. A program that displays Web contents via a network, and instructs a computer to execute:
a display means that displays Web contents in a first display area;
a noticed information extracting means that extracts information noticed by a user in the first display area; and
a second display means that displays results of searching with the information as search keys in a preset second display area as second information.

13. The program according to claim 12,
wherein the noticed information extracting means decides an area for extraction from the Web contents, based on a history of user display operations, and extracts information within the area as information noticed by the user.

14. An information providing server that provides information to a browser of a terminal connected via a network, including a third information transmitting means of:
for each item to be searched for, transmitting an information list containing information for search and a link to third information to the browser, and
searching for the information for search within the terminal, and transmitting the third information for display to the browser of the terminal, based on link information appended to search results.

15. The program according to claim 12,
which receives the information list from the information providing server that provides information to a browser of a terminal connected via a network, including a third information transmitting means of: for each item to be searched for, transmitting an information list containing information for search and a link to third information to the browser, and searching for the information for search within the terminal, and transmitting the third information for display to the browser of the terminal, based on link information appended to search results, and
uses the search keys in a preset second display area as second information to search the information list based on the information for search within the terminal and transmitting the third information for display to the browser of the terminal, based on link information appended to search results.

16. The program according to claim 13,
which receives the information list from the information providing server that provides information to a browser of a terminal connected via a network, including a third information transmitting means of: for each item to be searched for, transmitting an information list containing information for search and a link to third information to the browser, and searching for the information for search within the terminal, and transmitting the third information for display to the browser of the terminal, based on link information appended to search results, and
uses the search keys in a preset second display area as second information to search the information list based on the information for search within the terminal, and transmitting the third information for display to the browser of the terminal, based on link information appended to search results.
